(19) United States
(12) Patent Application Publication
(10) Pub. No.: US 2017/0083229 A1
(43) Pub. Date: Mar. 23, 2017

(54) MAGNIFYING DISPLAY OF TOUCH INPUT OBTAINED FROM COMPUTERIZED DEVICES WITH ALTERNATIVE TOUCHPADS

(71) Applicant: Handscape Inc., a Delaware Corporation, Fremont, CA (US)

(72) Inventors: Tong Luo, Fremont, CA (US); YiFan Chen, Fremont, CA (US)

(21) Appl. No.: 15/365,807

(22) Filed: Nov. 30, 2016

Related U.S. Application Data
(63) Continuation-in-part of application No. 15/280,796, filed on Sep. 29, 2016.
Application No. 15/280,796 is a continuation-in-part of application No. 14/341,326, filed on Jul. 25, 2014.
Application No. 14/341,326 is a continuation-in-part of application No. 14/289,260, filed on May 28, 2014, now Pat. No. 9,542,032.
Application No. 14/289,260 is a continuation-in-part of application No. 14/284,068, filed on May 21, 2014.
Application No. 14/284,068 is a continuation-in-part of application No. 14/282,331, filed on May 20, 2014.
Application No. 14/282,331 is a continuation-in-part of application No. 14/286,926, filed on May 23, 2014.
Application No. 14/286,926 is a continuation-in-part of application No. 14/260,195, filed on Apr. 23, 2014, now Pat. No. 9,430,147.
Application No. 14/289,260 is a continuation-in-part of application No. 13/770,791, filed on Feb. 19, 2013, now Pat. No. 9,311,724.
Application No. 13/770,791 is a continuation-in-part of application No. 12/773,075, filed on May 4, 2010, now Pat. No. 8,384,683.
Application No. 13/770,791 is a continuation-in-part of application No. 13/223,836, filed on Sep. 1, 2011, now Pat. No. 9,310,905.
Application No. 13/223,836 is a continuation-in-part of application No. 15/239,652, filed on Aug. 17, 2016.
(60) Provisional application No. 61/858,223, filed on Jul. 25, 2013.
(60) Provisional application No. 61/828,683, filed on May 30, 2013.
(60) Provisional application No. 61/825,621, filed on May 21, 2013.
(60) Provisional application No. 61/819,615, filed on May 5, 2013.
(60) Provisional application No. 61/815,068, filed on Apr. 23, 2013.
(60) Provisional application No. 61/327,102, filed on Apr. 23, 2010.
(60) Provisional application No. 62/234,497, filed on Sep. 29, 2015.
(60) Provisional application No. 62/205,891, filed on Aug. 17, 2015.

(51) Int. Cl. G06F 3/0488; G06F 3/0484

(52) U.S. Cl. CPC G06F 3/04883; G06F 3/04842; G06F 2203/04803; G06F 2203/04806; G06F 2203/04805; G06F 2203/04808

(57) ABSTRACT

An improved software magnifier for computerized devices equipped with touch sensitive display screens and touchpads located in locations separate from said touch sensitive display screens. In one embodiment, touch information from the touchpad is used to select an area of the screen to magnify, and both images and touch sensitive control areas from this area of the screen, which might normally be located too close together for easy selection, are also magnified. The user can then use the touch sensitive display screen to more conveniently select between these close together control areas by instead interacting with the magnified version of these control areas as shown in the magnified region of the screen.

### CROSS REFERENCE TO RELATED APPLICATIONS

This application is a continuation in part of U.S. patent application Ser. No. 15/280,796, filed Sep. 29, 2016; application Ser. No. 15/280,796 claimed the priority benefit of U.S. provisional application 62/234,497, filed Sep. 29, 2015; This application is also a continuation in part of U.S. patent application Ser. No. 15/239,652, filed Aug. 17, 2016; application Ser. No. 15/239,652 claimed the priority benefit of U.S. provisional application 62/205,891 filed Aug. 17, 2016; application Ser. No. 15/280,796 is also a continuation in part of U.S. Non-Provisional patent application Ser. No. 14/341,326, filed Jul. 25, 2014; application Ser. No. 14/341,236 claims the priority benefit of U.S. Provisional Patent Application No. 61/858,223, filed Jul. 25, 2013; application Ser. No. 14/341,326 is also a continuation-in-part of U.S. patent application Ser. No. 14/289,260, filed May 28, 2014; application Ser. No. 14/289,260 claims the priority benefit of U.S. provisional application 61/828,683 filed on May 30, 2013; this application is also a continuation-in-part of U.S. patent application Ser. No. 14/284,068 filed on May 21, 2014; application Ser. No. 14/284,068 claims the priority benefit of U.S. provisional application 61/825,621 filed on May 21, 2013; this application is also a continuation-in-part of U.S. patent application Ser. No. 14/282,331 filed on May 20, 2014; this application is also a continuation-in-part of U.S. patent application Ser. No. 14/268,926 filed on May 2, 2014; application Ser. No. 14/268,926 claims the priority benefit of U.S. provisional application 61/819,615 filed on May 5, 2013; application Ser. No. 14/268,926 is also a continuation-in-part of U.S. patent application Ser. No. 14/260,195 filed Apr. 23, 2014, now U.S. Pat. No. 9,430,147; application Ser. No. 14/268,926 also claims the priority benefit of U.S. provisional application 61/815,058 filed on Apr. 23, 2013; application Ser. No. 14/286,926 is also a continuation-in-part of U.S. patent application Ser. No. 13/770,791 filed Feb. 19, 2013, now U.S. Pat. No. 9,311,724; application Ser. No. 13/770,791 is a continuation in part of application Ser. No. 12/773,075 filed on May 4, 2010, now U.S. Pat. No. 8,384,683; application Ser. No. 12/773,075 claims the priority benefit of U.S. provisional patent application 61/327,102 filed on Apr. 23, 2010; application Ser. No. 13/770,791 is also a continuation-in-part of U.S. patent application Ser. No. 13/223,836 filed on Sep. 1, 2011, now U.S. Pat. No. 9,310,905; the contents of all of these applications are incorporated herein by reference in their entirety.

### BACKGROUND OF THE INVENTION

Field of the Invention

This invention is in the field of improved user interfaces for computerized devices.

Description of the Related Art

Users with limited vision that desire to read small text and other printed indicia often use magnifier lenses to magnify the size of the text. As computer technology has advanced, and more users with limited vision attempt to read display screens, so various types of assistive technology have been developed that allow users to apply software implemented virtual magnifiers to various parts of the computer display screen.

In a related development, as smartphones and other handheld computerized devices with small but high resolution touch screens have developed, the problem of how best to view and interact with small sized text and touch sensitive icons, with normal sized fingers, has also become apparent. This is often referred to as the “fat finger” problem. Prior art methods at finding solutions to the “fat finger” problem have been less satisfactory. Generally solutions have focused on autocorrect mechanisms to correct typing problems, and the like.

Previous work in this area includes Kocienda et. al., U.S. Pat. No. 8,661,362. Other work includes Zaman, U.S. Pat. No. 8,176,438; and Foulk, US patent publication 2009/0027334. Various types of magnifiers have also been implemented in popular operating systems such as the Microsoft Windows Magnifier, present in Windows 7.0 and other versions of Windows.

### BRIEF SUMMARY OF THE INVENTION

The invention is based, in part, on the insight that at least with regards to touchscreens, prior art computerized magnifier technology tended to suffer from the problem that if the user's hand was used to designate the portion of the touchscreen that was to be magnified, then this hand would also tend to both obscure the touchscreen, and also make it difficult to select narrowly separated interactive icons on the screen for further interaction.

This invention is also based, in part, on the insight that the inventor's teaching of computerized devices that have both touchscreens, and also additional touchpads mounted in locations away from the touchscreen (such as in the rear of a handheld computerized device, behind a front mounted touchscreen) can be used to provide an improved interactive magnifier system for the user.

As a simple example, consider the situation where the user is attempting to interact with a smartphone, such as the popular Apple iPhone 4-7 series of smartphones, and magnify a portion of the screen so as to make it easier to type on a virtual keypad (with many tiny keys). Such prior art smartphones typically only have front mounted touchscreens. However if the smartphone is also equipped with a rear mounted touchpad, such as taught by applicant in his previous U.S. Pat. No. 9,310,905, the entire contents of which are incorporated herein by reference, then with appropriate software, this rear mounted touchpad may be used to help provide an improved interactive magnifier for the user.

The concept is not limited to detachable touchpads, however. Alternatively computerized devices with built in touchpads, or even remote touchpads, may also be used according to the present disclosure.

In some embodiments, the user may use the touchpad to indicate a position of interest (provide magnifier target data) pertaining to a location on the front mounted touchscreen that the user wishes to have magnified. The computerized device's processor can receive this magnifier target data, optionally display a magnification target marker in this location, and magnify that portion of the screen proximate (around) the location designated by this magnifier target data, optionally along with any associated touch sensitive control areas. The system can then produce a magnified portion of the screen around this location, and place the magnified version in a different location on the display screen (e.g. often displaced from the location designated by the magnifier target data).

In a preferred embodiment, the system will not only magnify a portion of the screen image, but also magnify and reproduce any touch sensitive control areas associated with this image so that the user, perhaps wishing to activate a key or other icon within the magnified image, can interact directly with the magnified image rather than the unmagnified original target, and have the results used by the system as if the user had correctly touched the corresponding unmagnified portion of the screen.

Thus in some embodiments, the invention may be an improved interactive software magnifier for computerized devices equipped with both touch sensitive display screens, and touchpads located in locations separate from the touch sensitive display screens. In one embodiment, touch location information from the touchpad can be used to select an area of the screen to magnify, and any touch sensitive control areas from this area of the screen, which might normally be located too close together for easy selection, can also be magnified. The user can then use the touch sensitive display screen to more conveniently select between these close together control regions by instead interacting with the magnified version of these control regions on the magnified region of the screen.

### BRIEF DESCRIPTION OF THE DRAWINGS

FIG. 1A shows a front view of a computerized device equipped to implement the present invention. Here a smartphone with a front mounted touchscreen and a rear mounted touch pad is shown.

FIG. 1B shows the same computerized device, except that now another digit on the user's hand, such as the thumb, is now touching a different position on the front touchscreen.

FIG. 2A shows the user's finger indicating, on the back touchpad, a target area of interest displayed on the front touchscreen that the user wishes to have magnified.

FIG. 2B shows that the system using the information from the magnifier target data provided in FIG. 2A to compute and display a visible magnification target marker (small circle) and also a magnified portion of the display screen.

FIG. 2C shows the user's front thumb selecting a “d” key from this magnified portion of the display screen. Here the magnified portion has also reproduced the touch sensitive areas of the original target.

FIG. 2D shows the user's front thumb selecting an “f” key from this magnified portion of the display screen.

FIG. 3A shows the user's finger moving on the touchpad in the back of the device to indicate a different target area of interest (between the “u” and “e” virtual keys) to be magnified.

FIG. 3B shows that the system is now automatically displaying the magnification target marker (the small circle between the “u” and “e” virtual keys) in a new location, and is also now showing an updated magnified portion of the display screen showing this new location.

FIG. 3C shows the user's thumb selecting the “u” key from the updated magnified portion.

FIG. 3D shows the user's thumb selecting the “e” key from the updated magnified portion.

FIG. 4A shows the user's finger on the back touchpad sliding from a first target area of interest (magnification target) between the virtual “d” and “f” keys up to a new target location between the virtual “u” and “e” keys.

FIG. 4B shows that as a result of the user's finger on the back touchpad sliding to the second target area of interest between the virtual “u” and “e” keys, the magnified portion of the display screen now shows the second target area of interest, which is the area proximate (around) the new location of the magnification target.

FIG. 5 is front touch screen oriented view of a small handheld computerized device (100), such as a smartphone equipped with both a front mounted touchscreen and a rear mounted touchpad.

FIG. 6 shows a block diagram showing the major components and data flow among the front panel touchscreen, back panel touch pad, device processor, software, and the device memory.

FIG. 7 shows a flowchart showing some of the major software steps according to one embodiment of the invention.

FIG. 8 shows an exploded perspective drawing of a device similar to FIG. 5, showing the separation between the touchpad and the touchscreen according to one embodiment of the invention.

FIG. 9 shows that the touchpad need not be an integral part of the computerized device but instead can be mounted on a detachable touchpad device that may, for example, fit on the back of the computerized device.

### DETAILED DESCRIPTION OF THE INVENTION

In this disclosure, the term “touchscreen” is considered to be the main viewing screen, often located on the front of a computerized device, by which the user receives visual information from the computerized device. This touchscreen typically will also be configured to receive touch information from the user and to report on the screen coordinates where this touch information was detected.

The term “touchpad” is considered to be a supplemental touch input system, often located on the back panel of the computerized device, also configured to receive touch information from the user and to report on the touchpad coordinates where this touch information was detected. Note that in some embodiments, the touchpad may also have display capability, and in these embodiments, the system may be considered to have multiple touchscreens. In these embodiments, the secondary touchscreen used to input the magnifier target location (to be described) will be considered to be functioning as the “touchpad”.

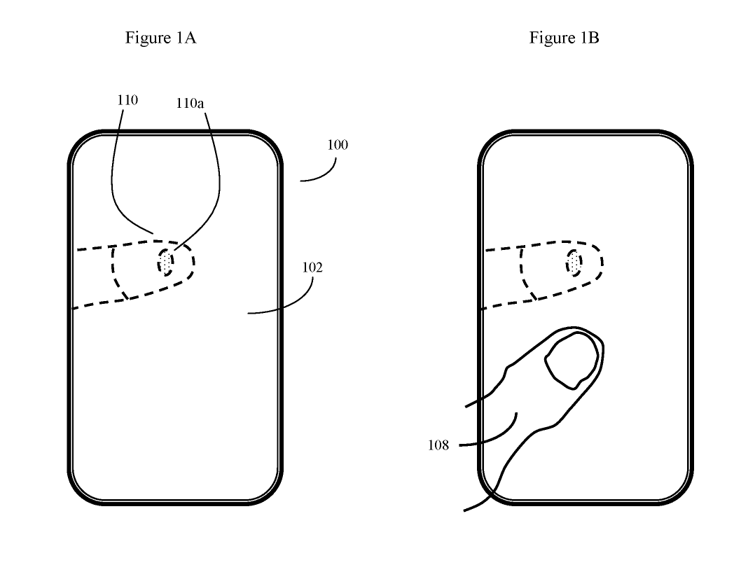

As shown in FIGS. 1A to 4B, in some embodiments, the invention may be a system or method for magnifying and selecting objects on a display screen of a computerized device. This computerized device may be a smartphone or computer tablet device (100), but could also be a laptop computer with a touch sensitive display screen and a supplemental touchpad, vehicle mounted computer system, or other type of computerized device.

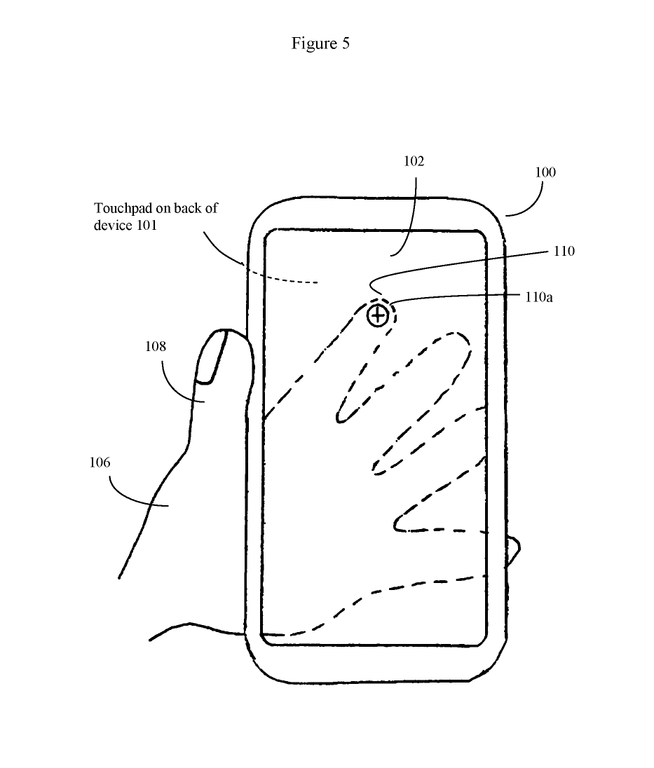

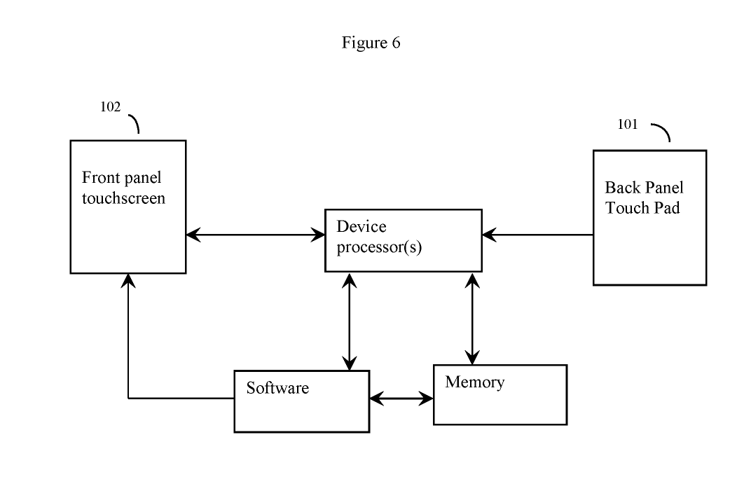

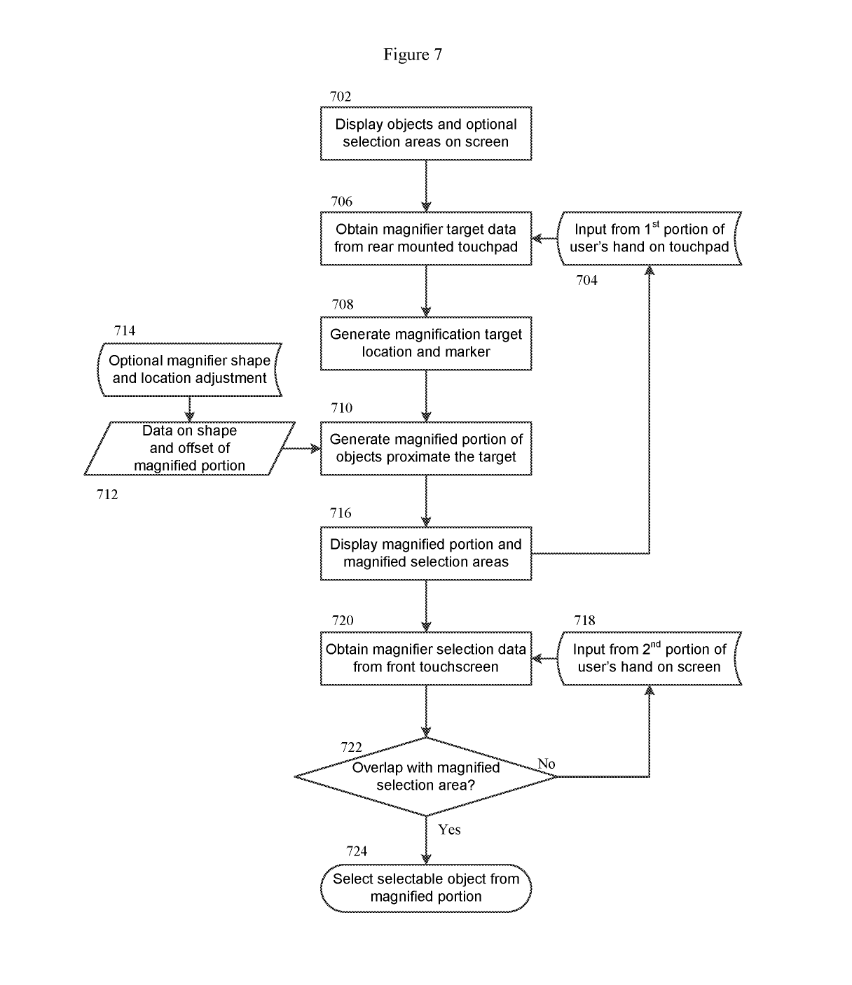

The computerized device may either have, or be retrofitted to have, at least one touchpad (101), at least one display screen (often a touch sensitive display screen 102), at least one processor, memory, and software. An example of the circuitry of this type of device is shown in FIG. 6, and an illustration of various embodiments of this type of device is also shown in FIGS. 5, 8, and 9. A flow chart exemplifying some of the steps that may be implemented by software running one embodiment of this system and method is shown in FIG. 7.

FIG. 1A shows a front view of a computerized device equipped to implement the present invention. As previously discussed, this can be a smartphone with a front mounted touchscreen (102) and a rear mounted touch pad (101) (see FIGS. 5, 6, and 7). Here assume that the front mounted touchscreen (102) is the same size and shape as the rear mounted touchpad (101), and that (at least through software mapping), there is a 1:1 correspondence between the touchpad coordinates and the touchscreen coordinates.

Further assume that the front mounted touchscreen (102) is exactly in front of the rear mounted touchpad (101), and that any bezel surrounding the front mounted touchscreen is not shown. Here the user is gripping the computerized device with a left hand, and one of the user's fingers (110) is touching the rear mounted touchpad at a contact point (110a).

FIG. 1B shows the same computerized device, except that now another digit on the user's hand, such as the thumb (108), is now touching a different position on the front touchscreen (102).

According to some embodiments of the invention, when this happens, the system processor may recognize that an initialization touch sequence designed to implement magnifier functionality is now present. In other embodiments, alternative methods to implement magnifier functionality, such as specific tap sequences, icon presses, physical key input, sound input (e.g. voice recognition), or other magnifier trigger methods may be used.

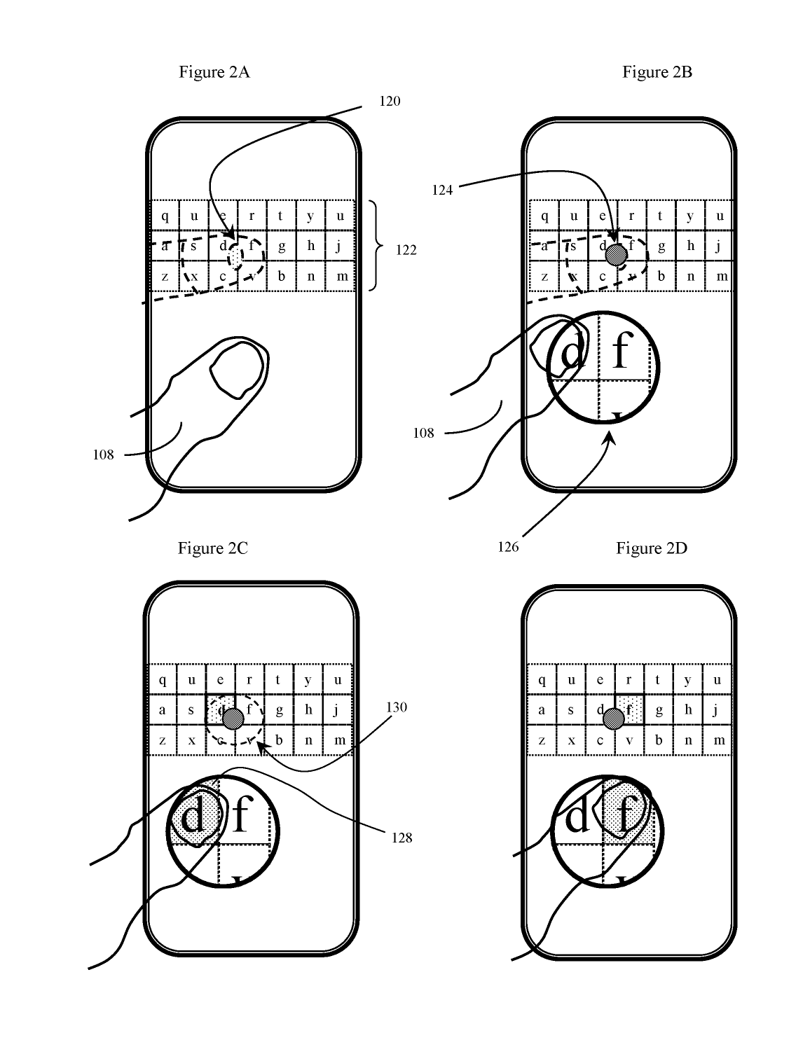

FIG. 2A shows the user's finger (110) indicating (110a), on the back touchpad, a target area of interest displayed on the front touchscreen that the user wishes to have magnified. This touchpad input may either be converted at the touchpad into corresponding magnifier target data (120), or alternatively raw data from the touchpad may be transmitted to the device processors, where after an optional mapping process, the magnifier target data (120) is produced.

Here the target area of interest (magnifier target data 120) is located on at least one selectable object (122), which is here a small virtual keyboard composed of a plurality of selectable objects (here the objects are the individual, touch sensitive, virtual keys). The magnifier target data (120) is designating a target area between the “d” and “f” virtual keys. In this example, the virtual keys are shown being placed too closely together to allow for easy finger typing on the unmagnified section of the display screen, which is a common problem for smartphones and other small handheld computerized devices.

FIG. 2B shows that the system using the information from the magnifier target data (120) to compute and display both a visible magnification target marker (small circle 124) and also a magnified portion of the display screen (126). In this magnified portion, the device processor(s) have magnified the region originally displayed close to (proximate) the magnification target (120) (and target marker 124). The device is now showing this magnified region, on a location of the display screen that is in a different location (i.e. the location is displaced) from the magnification target (120) and marker (124). The user has not yet selected any key or icon of interest on this magnified portion (126), however.

FIG. 2C shows the user's front thumb selecting the “d” key from the magnified portion, thus creating magnifier selection data (128) for the “d” key. Thus the system is producing an interactive magnifier that can simultaneously work with touch data from both the touchscreen and the touchpad.

The user's finger (110) is not shown. The dashed lines (130) show the region proximate (close to) the magnification target and marker (124), which is being magnified by the device processor and shown in the magnified portion of the display screen (126)

FIG. 2D shows the user's front thumb selecting the “f” key from the magnified portion, thus generating different magnifier selection data for the “f” key.

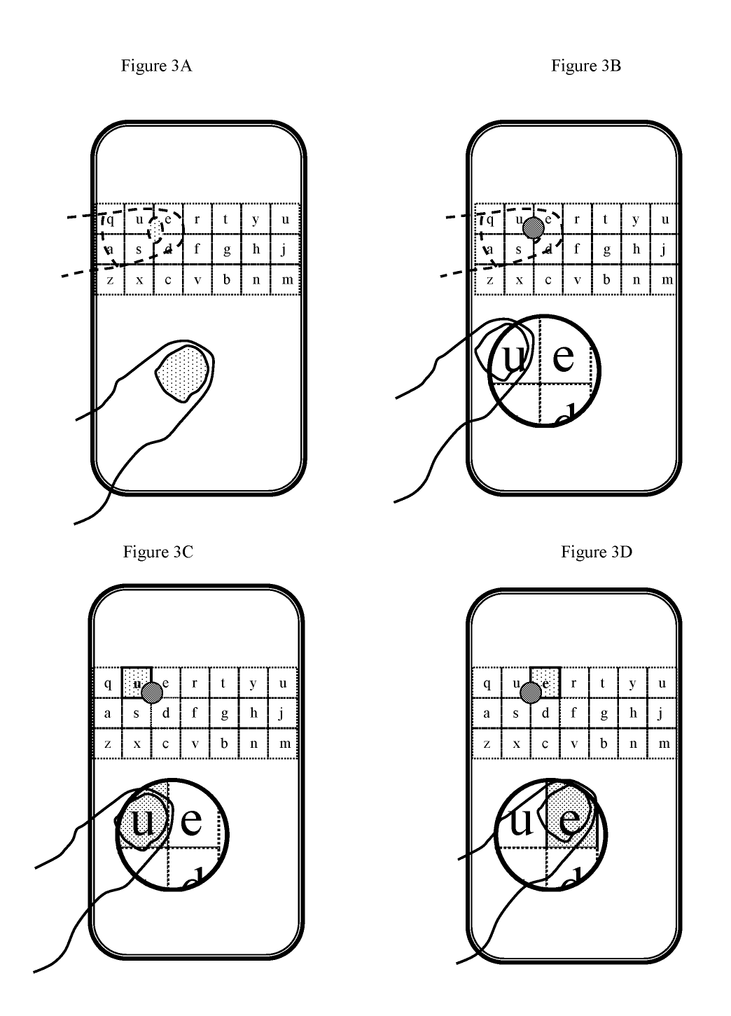

FIG. 3A shows the user's finger moving on the touchpad on the back of the device to indicate a different target area of interest (between the “u” and “e” virtual keys) on the front touchscreen that the user wishes to have magnified.

FIG. 3B shows that the system is now automatically displaying the magnification target marker (the small circle between the “u” and “e” virtual keys) in a new location, and is now also showing an updated magnified portion of the display screen that corresponds to this different target area of interest. Here the user's thumb is positioned above the magnified portion of the display screen but is not yet selecting any magnified selectable object to press.

FIG. 3C shows the user's thumb selecting the “u” key from the updated magnified portion.

FIG. 3D shows the user's thumb selecting the “e” key from the updated magnified portion.

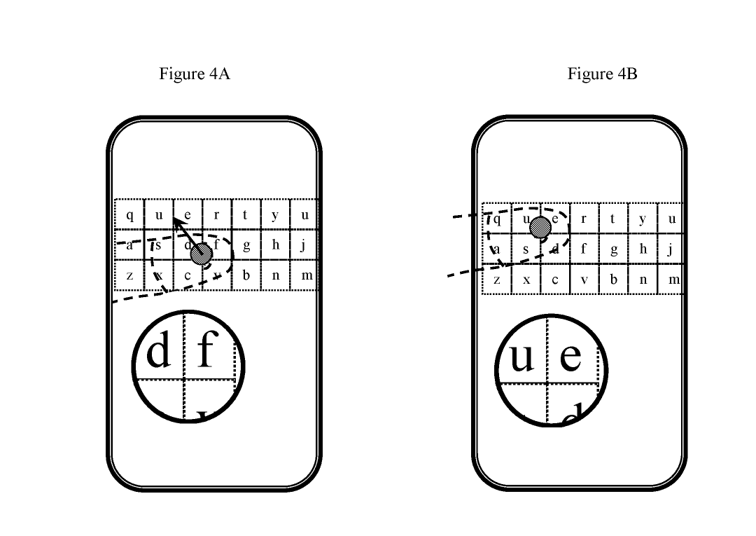

FIG. 4A shows the user's finger on the back touchpad sliding from a first target area of interest (magnification target) between the virtual “d” and “f” keys up to a new target location between the virtual “u” and “e” keys. The magnified portion of the display screen shows a magnified version of the first target area of interest proximate (close to) the first location of the magnification target marker.

FIG. 4B shows that as a result of the user's finger on the back touchpad sliding to the second target area of interest between the virtual “u” and “e” keys, the magnified portion of the display screen now shows a magnified version of the second target area of interest, which is the area proximate (by) the new location of the magnification target marker.

FIG. 5 is front touch screen oriented view of a small handheld computerized device (100), such as a smartphone, equipped with both a front mounted touchscreen and a rear mounted touchpad, displaying the position and motion of one finger (110) in contact (110a) with the touchpad (101). The user's hand is indicated as (106), and the user's thumb is shown as (108). The contact between the finger and the touchpad (110a) is transmitted to the device processor(s). If not done automatically by the touchpad, the processor(s) determines the correspondence (e.g. does a mapping) between the touchpad coordinates and the corresponding touchscreen coordinates, thus producing magnifier target data (120).

FIG. 6 shows a block diagram showing the major components and data flow among the front panel touchscreen (102), back panel touch pad (101), device processor, software, and the device memory.

FIG. 7 shows a flowchart showing some of the major software steps according to one embodiment of the invention.

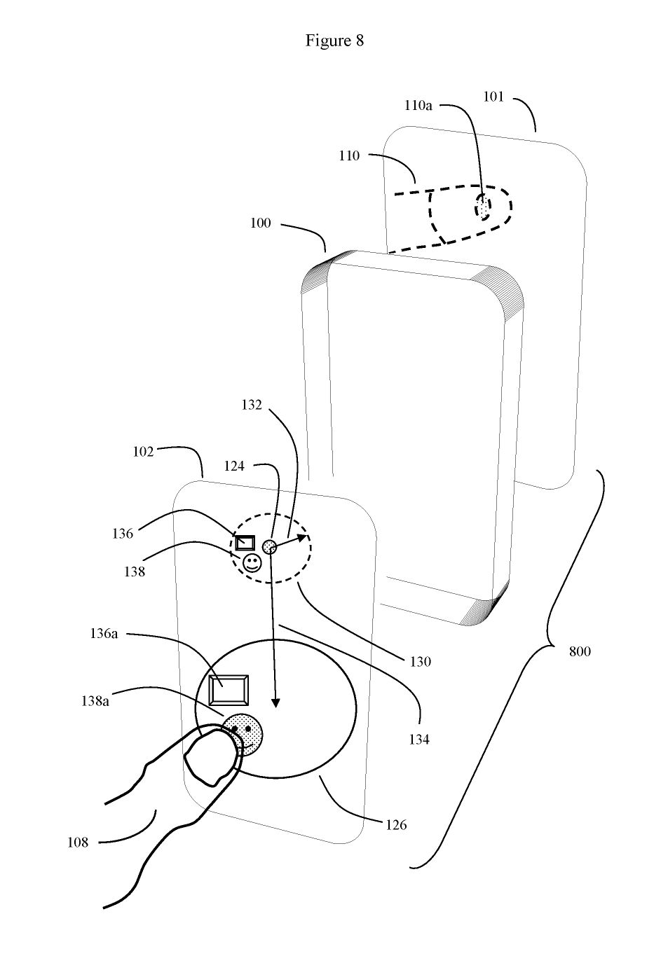

FIG. 8 shows an exploded perspective drawing (800) showing the separation between the touchpad and the touchscreen according to one embodiment of the invention. Here the unexploded version of the device is similar that previously shown in FIGS. 1A-5.

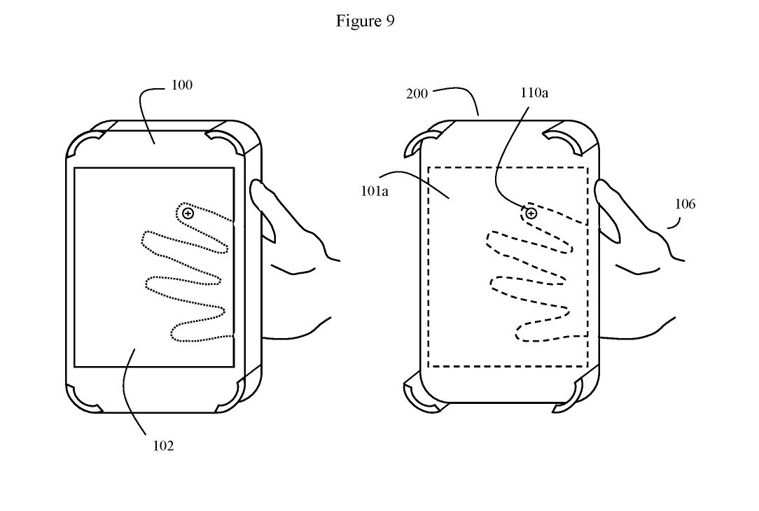

FIG. 9 shows that the touchpad need not be an integral part of the computerized device (100), but instead can be mounted on a detachable touchpad device (200). This in turn can attach to the back of a computerized device (100) equipped with a display screen or touchscreen (102).

In FIG. 9, the user's hand (106) at least one finger is touching (110a) a built-in touchpad (101a) on the back surface of a detachable touchpad device (200), which is in turn mounted on the back of the computerized device (100). In some embodiments, the back touchpad (101a) will recognize the position and locations of at least one point of contact (110a) between the user's fingers and the back touchpad, and transmit this data to the handheld computerized device which can take this touch location information, perform any additional mapping as needed, and produce the magnifier target data (120).

In other embodiments, the touchpad can be completely separate from the computerized device, and may communicate touchpad information to the computerized device using a wired or wireless connection.

Expressing the invention in methods terminology, in some embodiments, the computerized device may use its at least one processor (e.g. computer processor with at least one core, often based on the popular ARM, MIPS, x86, or other series of microprocessors) to display at least one object (122) on the display screen (102), (702) without magnification (e.g. at whatever level of magnification the user has selected as being preferred for that screen at that particular time).

This object or objects (122) may be any of text, images, icons and the like. These will usually be displayed on top of an underlying screen background image. This background image will often also be magnified by the invention's magnifier as well, thus preserving the overall appearance of the target region to be magnified, but otherwise this background image will not be discussed further, since our interest is focused on the specific objects (and in particular specific selectable objects) on top of the background image. When this object has associated touch sensitive areas associated with it that activate a software function when the system receives touchscreen input from in these areas, then the objects are termed “selectable objects”.

The display screen (preferably a touchscreen) will usually be a bit mapped display, often an electronic paper, LCD or OLED display, configured to obtain display information from the system processor(s) or memory, and often capable of outputting images at a resolution of 72 dots per inch or more, such as even hundreds of dots per inch. These images may be black and white images, gray scale images, or color images depending upon the type of display and output mode chosen.

In a preferred embodiment, at least some of the objects may be touch sensitive “selectable” objects that, in response to user touch input, will be recognized by the system processor as instructing the processor to perform a user selected function. Typically, the device processor and software recognize that when the system touchscreen is touched in an area that corresponds to the displayed object, the user may be intending to activate a software function associated with that particular object. Often the extent of this touch sensitive object activation area (here termed “corresponding touch sensitive areas”) matches the size and shape of the displayed object exactly. However this need not always be the case, and occasionally the size and shape of the touch sensitive object activation area (corresponding touch sensitive areas) may be somewhat larger or smaller than its corresponding image. Indeed in some cases, there need not be any corresponding image (i.e. hidden touch screen sensitive areas). For the purposes of this discussion, it does not matter. It should suffice that the system software that produces a magnified image of a given object or object of interest (as well as any background areas) also produces a magnified version of the corresponding touch sensitive area associated with that particular object (or background area) of interest, so that both the appearance and the touch activation functionality of the target region of interest are accurately reproduced on the magnified portion of the screen (in magnified and location displaced form) in a manner that preserves both the appearance and functionality of the original target region.

In this disclosure, we will often use a virtual keypad as an example of “at least one selectable object”, but this particular example is not intended to be limiting. This virtual keyboard is also an example of a plurality of selectable objects, because each virtual key on the virtual keyboard can be considered to be an individual selectable object. However non-selectable objects (e.g. objects not responsive to touchpad input (101) or touch sensitive display input 102) will often also be magnified, along with background regions as previously discussed.

The system will typically obtain the target location where the user wishes to magnify (e.g. the magnifier target data 120) directly or indirectly from the system touchpad(s) (101), which as shown in FIGS. 5, 8, and 9 may often be mounted opposite (e.g. behind) the device's display screen or touchscreen (102), or at some other location that that is different from the location of the display screen. Put alternatively, this magnifier target data (120) is obtained from, and is associated with (usually via a processor mediated mapping process) a position of a portion of at least one hand of a user (often one of the user's fingers 110) when the user operates the computerized device using the touchpad(s) and usually also the display screen. See FIG. 1A (110) and FIG. 5 (110). This process of obtaining input is also shown in FIGS. 7 (704 and 706).

Thus the user's finger (110) may press a touchpad (101) at location (110a) and the system processor will convert this signal to the corresponding magnifier target data (120). In effect, the coordinates of the user's touch (110a) on the touchpad (101) are mapped by the processor onto the coordinates of the device's touch screen (display screen) producing the magnifier target data (120).

The system will typically send touchpad data (110a) or (120), (704, 706) to its processor(s), and will use the processor(s) to generate the magnifier target data (120) as well as often a visible marker of the magnification target (124, 708) (visible target marker) corresponding to a portion of the display screen that in turn corresponds to the magnifier target data (120, 704, 706).

Put alternatively, in some embodiments, the location of the magnification target (124) will also be made visible (708) on the display screen by a marker (e.g. a small circle, dot, cross, or other indicia) as is shown in FIGS. 2B-2D, 3B-3D, and 4A-4B) while in other embodiments (708), the location of the magnification target (124) may not be invisible (e.g. no marker may be shown on the display screen/touchscreen 102).

The system will then use its processor(s) to generate (710) a magnified portion (126) of the region of the display screen proximate (e.g. near, often surrounding this target.) See FIG. 8 radius arrow 132 and dashed line 130) to the magnification target (124). This magnified portion essentially corresponds to the shape of the virtual “magnifying glass” that is used to magnify the target region of interest.

By “proximate”, this can, for example, be that portion of the display screen that is within a given radius (132) of the location of the magnification target (124), in which case the magnified portion (126) may be a circular magnified portion (shown in FIGS. 2B-2D, 3B-3D, 4A-4B and 8) not unlike that obtained using a circular magnifying glass. Any touch sensitive control areas associated with the objects will typically also be magnified.

Other magnification portion shapes (e.g. virtual magnifying lens shapes) are also contemplated as well. Just as real magnifying lenses can be rectangles and other types of shapes, so the magnifying portion shapes can also be various types of rectangles as well as other shapes. These other shapes, as well as other factors such as the amount of magnification, the area being magnified (130, 132), and the location of the magnified portion (See FIG. 8, 134, 126) may be selected by the user (714) and stored in system memory (712) for later use. Alternatively, these may be automatically set by the system to various default values.

Although typically the magnification factor will be positive (e.g. the magnified image will be larger than the target image), this is not intended to be limiting. Just as some types of real lenses can shrink the appearance of the target image in the magnifier, so to in some embodiments, the software magnification factor may be negative. This alternate embodiment may be useful for generating overviews of large images that are too big to otherwise fit in the device's display screen all at once.

The system will then typically display (716) this magnified portion (126) on a touch sensitive display screen (102), suitably matched with the magnified corresponding touch sensitive areas. As previously discussed, often, this magnified portion (126) will be displayed on a location of the display screen that is different (e.g. offset, see FIG. 8, 134) from the location of the magnification target (124). This thus allows the users to see the region around the magnification target (124) in both a normal (unmagnified 130) and magnified form (126). However embodiments where the magnified portion (126) is displayed over the magnification target (124) are not disclaimed. Indeed, as previously discussed, it may be useful to allow the user to select (FIG. 8, 714) the distance by which the magnified portion (126) is displaced (134) from the magnification target (124) as desired by the user. Other functions, (e.g. amount of magnification factor, from negative to positive), may also be software selected by the user as desired.

### Further Discussion

Although in some embodiments, the system may merely show the magnified portion of the screen (126) without also replicating and magnifying any touch sensitive control areas associated with the magnification target (124), in a preferred embodiment, the display screen's original touch sensitive control areas (FIG. 8 136, 138) proximate the magnification target (124) will also be replicated and shown and implemented (FIG. 8, 136a, 138a) in the magnified portion (126) as well.

Here the system will often operate by obtaining (FIG. 7, 718, 720) magnifier selection data from at least one of the touchpad (101) or the display screen (102) (in these examples, the magnifier selection data is obtained from a touch sensitive display screen 102).

Differences between magnifier target data and magnifier selection data.

The magnifier target data lets the system know what portion or area of the display screen to magnify. By contrast, the magnifier selection data represents user touches onto the magnified portion as displayed on the touchscreen, usually for purposes to select a selectable object that has been magnified by the system's virtual magnifier.

So to summarize, the magnifier target data (FIG. 2A, 120) is obtained from the position of the user's hand (e.g. the finger 110) that is contacting the touchpad at 110a (see FIG. 1A 110a, FIG. 5 110a, and FIG. 8 110a). This tells the system what part of the display screen the user wants to select to magnify, and to set as the magnification target location (124).

By contrast, the magnifier selection data (128) obtained from the touch sensitive display screen (102) is typically obtained using a different portion of the user's hand (such as the thumb) (FIG. 7, 718, 720, FIG. 8 108) different from that used to select the magnifier target. Again, the magnifier target data (120) is obtained from a direct touch (110a) to a touchpad (see FIG. 7 704, 706, and FIG. 8 110, 110a).

According to this terminology, the magnifier selection data (see FIG. 2C 128), FIG. 7 (716, 720) operates when selectable objects proximate (e.g. close to) the magnification target (124) are also magnified and implemented on the magnified portion (126) of the display screen (102).

This is shown in more detail in FIG. 8. In FIG. 8, two selectable objects (136, 138) are magnified by the system's virtual magnifying lens because they are proximate (close to) the magnification target (124). Here, for example, they fall within the magnification radius (132). Thus the graphical information associated with these selectable objects, along with the shapes of their control areas, is magnified and is shown as (136a, 136b) in the magnified portion (126).

As previously discussed, this magnifier selection data (128) will typically be associated with at least one alternative contact point of the user's hand or hands (e.g. the thumb 108) that falls within the magnified portion (126). This is shown in more detail in FIGS. 2C, 2D, 3C and 3D, as well as FIG. 8, and FIG. 7 steps (718 and 720).

As one example, consider FIGS. 2A-2D. Here the control areas associated with each virtual key in the virtual keyboard (122) proximate (130) or near the magnification target (124) are also magnified and reproduced in the magnified portion (126).

Here the user may use a “finger one” portion of the user's hand (the finger 110 at touchpad contact point 110a) to, via the system processor and FIG. 7 steps 704 and 708, select (120) the location of the magnification target (124).

The user may also use an alternative contact point of the user's hand(s) (here the thumb 108) to select the desired control area (e.g. one of the keys “d”, “f” in FIG. 2C-2D, or one of the keys “u” “e” in FIGS. 3C-3D), and thus obtain the magnifier selection data (128). This is done according to steps outlined in FIG. 7 (728, 724). Note that in this scheme, the input from a different portion of the user's hand on the touchscreen (102), such as the user's thumb (108) is tested by the system processor, and the processor determines if the location of this input overlaps with the location of the selectable object (722).

Using this sort of scheme, the system can then use this magnifier selection data (128) to select the at least one selectable object (122) (here one of the keys) that is displayed in higher magnification in the magnified portion (126) on the display screen (102). See also FIG. 8, which shows the user's thumb (108) selecting a magnified form (138a) of the selectable object (138).

Put alternatively, as is shown in FIGS. 1A to 4C and FIG. 8, in some embodiments (often preferred embodiments) the at least one display screen (102) is a touch sensitive display screen located on a front of the device. Here the use can select the magnification target (124) by using a portion the user's hand (e.g. finger 110) to touch the touchpad at (110a). This touch is eventually registered by the touchpad and system as the magnifier target data (120). See FIG. 7 steps (702-706).

The user can further select at least one selectable object (here represented by the various keys in the virtual keypad 122 in FIG. 2A, and by FIGS. 8 136 and 138) by using a different portion of the user's hand(s), such as the user's thumb (108), and the system's touch sensitive display screen (102) to select (128) at least one selectable object (such as various keys) that are displayed in higher magnification (e.g. FIG. 8 136a, 138a) in the magnified portion on the display screen (126). As previously discussed, as shown in FIGS. 5-6 and 8-9 in some embodiments, this at least one touchpad (101) may be mounted on the back side of the device. See also FIG. 7 steps 708-724.

As previously discussed, in some embodiments, the magnified portion of the display screen (126) produced by magnifying images (and often touch sensitive control areas such as FIGS. 8 136 and 138) proximate (130) the magnification target (124) (e.g. selected by the location of the magnification target) can be various shapes. Although the figures portray the shape of this magnified portion (126) as circular, other shapes, such as rectangular, triangular, or other type shapes may be used. To help make the use more intuitive, however, it is often useful to pick a shape that corresponds to the shape of a common physical magnifying lens (e.g. a circular or rectangular shape).

As shown in FIG. 8, in some embodiments, the magnified portion (126) will be a magnified portion of all portions of the display screen within a certain radius (132) of the magnification target (124), e.g. everything within region (130), at least when the magnification target is sufficiently far enough away from the side of the screen. When the magnification target (124) is close to the edge of the screen, some clipping will of course occur, and this can be reflected in the magnified portion (126). Alternatively, the length of this radius (132) or other magnifying function may vary (e.g. as a function of angle) to create rectangular or other shaped magnified portions (126). Thus often the center of the shape of the magnified portion will be filled with a magnified portion of the display screen, often with a center that corresponds to the location of the magnification target (124).

Typically, the system will be configured so that the user can switch the magnifier functionality (and the corresponding magnified portion of the display screen 126) on or off by appropriate software selection steps. In a preferred embodiment, the location of the magnified portion (such as the displacement (FIG. 8, 134) of the magnified portion (126) away from the magnification target (124) can also be software selectable by the user, as shown in FIG. 7 (714). Here various user interfaces, such as various taps on touch sensitive touchpads, touchscreens, or other methods may be used for this configuration (software selection) process.

Often, the location of the magnified portion (126) may be selected to be convenient to at least one thumb (108) or other user finger that the user favors for touch control purposes while the user is holding the computerized device (100).

Various software and hardware techniques may be used to generate the images and selectable areas on both the display screen and the magnified portion of the display screen (126). In some embodiments, the system may use its processor(s) to display at least one selectable object (122), FIG. 8 (136, 138) on the display screen without magnification by rending the display screen at a first (typically lower) magnification size. The system can then use its processor(s) to generate a magnified portion of the display screen (126), FIG. 8 (136a, 136b).

Here, as shown in FIG. 7 steps 702-714, the processor can take as input, data pertaining to the location of the user's hand on the touchpad (101, 110a, 120, 704), as well as the magnifier shape and relative location specifications (714, 712), the location of the magnification target (124). The processor can then use this information to render this portion of the display screen (130) (e.g. the portion proximate the magnification target (124)) and any corresponding touch sensitive regions (e.g. 136, 138) in this area, at a second (and typically higher) magnification size, as is shown in FIG. 7, 136a, 138a, 126.

The device processor(s) can then overlay a portion of the data used to generate the display screen with the data used to generate the magnified portion of the display screen (126). This thus creates composite display screen data on touchscreen (102) that contains the unmagnified display screen images and touch sensitive regions in the background (130, 136, 138) overlaid by the magnified portion of the display screen (126, 136a, 138a).

1. A method for magnifying and selecting objects on a display screen of a computerized device, said computerized device comprising at least one touchpad, at least one display screen, at least one processor, memory, and software, said method comprising:
using said at least one processor to display at least one object on said display screen at a first magnification;
obtaining magnifier target data from said at least one touchpad, said at least one touchpad being located in a location that is different from the location of said display screen, said magnifier target data being associated with a position of a portion of at least one hand of a user when the user operates said computerized device using said at least one touchpad;
transmitting said magnifier target data to said at least one processor, and using said at least one processor to generate a magnification target corresponding to a portion of said display screen in accordance with said magnifier target data;
using said at least one processor to generate a magnified portion of said display screen proximate said magnification target, and displaying said magnified portion on a location of said display screen;
wherein said magnified portion shows said at least one object at a second magnification.

2. The method of claim 1, wherein said at least one object is at least one selectable object with corresponding touch sensitive areas;
obtaining magnifier selection data from at least one of the touchpad or the display screen, said magnifier selection data being associated with at least one alternative contact point of said at least one hand of said user that falls within said magnified portion;
wherein said magnified portion shows said at least one selectable object and implements corresponding touch sensitive areas at a second magnification
and using said magnifier selection data to select said at least one selectable object that is displayed in higher magnification in said magnified portion on said display screen.

3. The method of claim 1, further using said at least one processor to generate a magnified portion of said display screen proximate said magnification target, and displaying said magnified portion on a location of said display screen that is different from a location of said magnification target.

4. A method for magnifying and selecting objects on a display screen of a computerized device, said computerized device comprising at least one touchpad, at least one display screen, at least one processor, memory, and software, said method comprising:
using said at least one processor to display at least one selectable object with corresponding touch sensitive areas on said display screen at a first magnification;
obtaining magnifier target data from said at least one touchpad, said at least one touchpad being located in a location that is different from the location of said display screen, said magnifier target data being associated with a position of a portion of at least one hand of a user when the user operates said computerized device using said at least one touchpad;
transmitting said magnifier target data to said at least one processor, and using said at least one processor to generate a magnification target corresponding to a portion of said display screen in accordance with said magnifier target data;
using said at least one processor to generate a magnified portion of said display screen proximate said magnification target, and displaying said magnified portion on a location of said display screen that is different from a location of said magnification target;
wherein said magnified portion shows said at least one object and implements corresponding touch sensitive areas at a second magnification;
obtaining magnifier selection data from at least one of the touchpad or the display screen, said magnifier selection data being associated with at least one alternative contact point of said at least one hand of said user that falls within said magnified portion;
and using said magnifier selection data to select said at least one selectable object that is displayed in higher magnification in said magnified portion on said display screen.

5. The method of claim 4, wherein said at least one display screen is a touch sensitive display screen located on a front of said device;
Wherein said device is configured to allow said user to select said magnification target by using a portion of at least one hand to touch said at least one touchpad; and wherein said device is configured to further allow said user to further select at least one selectable object by using a different portion of said at least one hand, and said touch sensitive display screen, to select said at least one selectable object that is displayed in higher magnification in said magnified portion on said display screen.

6. The method of claim 5, wherein said at least one touchpad is mounted on a back of said device.

7. The method of claim 5, wherein said magnified portion of said display screen proximate said magnification target comprises a circular, rectangular, or other shaped portion of said display screen with a center corresponding to the location of said magnification target.

8. The method of claim 5, wherein a presence or absence of said magnified portion of said display screen is software selectable by said user.

9. The method of claim 5, wherein said location of said magnified portion is user adjustable.

10. The method of claim 5, wherein said location of said magnified portion is selected to be accessible to at least one thumb or other user finger of a hand that a user selects for touch control purposes while said user is also using said hand to hold said computerized device.

11. The method of claim 5, wherein using said at least one processor to display at least one selectable object on said display screen without magnification comprises using said at least one processor to render said display screen at a first magnification size;
wherein using said at least one processor to generate a magnified portion of said display screen proximate said magnification target comprises using said at least one processor to render at least said portion of said display screen and any touch sensitive regions proximate said magnification target at a second magnification size; and
wherein said at least one processor overlays a portion of the display screen with said magnified portion of said display screen.

12. A method for magnifying and selecting objects on a display screen of a computerized device, said computerized device comprising at least one touchpad, at least one display screen, at least one processor, memory, and software, said method comprising:
using said at least one processor to display at least one selectable object with corresponding touch sensitive areas on said display screen at a first magnification size;
wherein said at least one display screen is a touch sensitive display screen located on a front of said device;
obtaining magnifier target data from said at least one touchpad, said at least one touchpad being located in on a back of said device, said magnifier target data being associated with a position of a portion of at least one hand of a user when the user operates said computerized device using said at least one touchpad;
transmitting said magnifier target data to said at least one processor, and using said at least one processor to generate a magnification target corresponding to a portion of said display screen in accordance with said magnifier target data;
using said at least one processor to generate a magnified portion of said display screen proximate said magnification target, and displaying said magnified portion at a second magnification size on a location of said display screen that is different from a location of said magnification target;
wherein said magnified portion shows said at least one selectable object and implements corresponding touch sensitive areas at a second magnification;
obtaining magnifier selection data from at least one of the touchpad or the display screen, said magnifier selection data being associated with at least one alternative contact point of said at least one hand of said user that falls within said magnified portion;
and using said magnifier selection data to select said at least one selectable object that is displayed in higher magnification in said magnified portion on said display screen.

13. The method of claim 12, wherein said device is further configured to allow said user to select said magnification target by using a portion of at least one hand to touch said at least one touchpad; and wherein said device is configured to further allow said user to further select at least one selectable object by using a different portion of said at least one hand, and said touch sensitive display screen, to select said at least one selectable object that is displayed in higher magnification in said magnified portion on said display screen.

14. The method of claim 13, wherein said location of said magnified portion is selected to be accessible to at least one thumb or other user finger of a hand that a user selects for touch control purposes while said user is also using said hand to hold said computerized device.

15. A computerized device comprising at least one touchpad, at least one display screen, at least one processor, memory, and software;
said device configured to use said at least one processor to display at least one object on said display screen at a first magnification;
said device further configured to obtain magnifier target data from said at least one touchpad, said at least one touchpad being located in a location that is different from the location of said display screen, said magnifier target data being associated with a position of a portion of at least one hand of a user when the user operates said computerized device using said at least one touchpad;
said device further configured to transmit said magnifier target data to said at least one processor, and use said at least one processor to generate a magnification target corresponding to a portion of said display screen in accordance with said magnifier target data;
said device further configured to use said at least one processor to generate a magnified portion of said display screen proximate said magnification target, and display said magnified portion showing at least one magnified object at a second magnification on a location of said display screen;
said device further configured to receive user selection of said at least one magnified object from said display screen.

16. The device of claim 15, wherein said at least one object is at least one selectable object with corresponding touch sensitive areas;
wherein said device is further configured to obtain magnifier selection data from at least one of the touchpad or the display screen, said magnifier selection data being associated with at least one alternative contact point of said at least one hand of said user that falls within said magnified portion;
wherein said magnified portion shows said at least one selectable object and implements corresponding touch sensitive areas at a second magnification;
wherein said device is further configured to use said magnifier selection data to select said at least one selectable object that is displayed in higher magnification in said magnified portion on said display screen.

17. The device of claim 15, wherein said device is further configured to use said at least one processor to generate a magnified portion of said display screen proximate said magnification target, and display said magnified portion on a location of said display screen that is different from a location of said magnification target.
